(19) United States
(12) Patent Application Publication
(10) Pub. No.: US 2012/0192766 A1
(43) Pub. Date: Aug. 2, 2012

(54) SYSTEM AND METHOD FOR METERING AND ADDING FIBRES TO A CEMENT MATRIX

(76) Inventor: Francesco Ferraiolo, Ca' de' Fabbri (Bologna) (IT)

(21) Appl. No.: 13/390,661

(22) PCT Filed: Jul. 23, 2010
(86) PCT No.: PCT/IB2010/053358

§ 371 Date: Feb. 15, 2012

(30) Foreign Application Priority Data
Aug. 6, 2009 (IT) BO2009A000531

(51) Int. Cl. C04B 12/00

(52) U.S. Cl. 106/638

(57) ABSTRACT

A system for metering and adding fibres to a cement matrix comprising means (3) for supplying the fibres and means (5) for conveying the fibres designed to convey them, in use, from the supply means (3) to the cement matrix. The conveyor means (5) are closed with respect to the surrounding environment. The present invention also relates to a method for metering and adding fibres to a cement matrix comprising the stage of supplying predetermined quantities of fibres by means of a supply device (3), and conveying these predetermined quantities of fibres from the supply device (3) to a predetermined position while keeping these fibres isolated from the surrounding environment.

The present invention relates to the sector of production of artificial conglomerates for use as construction materials, and in particular to the sector of machinery and systems for its industrial production. The invention has been developed with particular reference to a system and a method for metering and adding fibres to a cement matrix.

The production of artificial conglomerates as construction materials is nowadays carried out by centralised or on-site plant comprising an automatic production management system. The composition of the conglomerates is closely linked to the requirements that they have to satisfy and has to take account of many variables such as mechanical strength, durability, workability, casting method, maturation and the like.

It is also known to meter and add fibres, made from both metal and synthetic materials, to construction materials such as concrete, mortar or cement when they are still in their fluid state. The addition of these fibres makes it possible to modify and improve the technical properties of the materials and at the same time to resolve a whole range of problems typical, for instance, of cement conglomerate or lime-based products.

It is known in particular to provide synthetic fibres in containers, for instance sacks, so that a skilled operator can add a predetermined quantity of these fibres directly to the cement matrix in accordance with the properties with which it is intended to provide the final product.

One of the drawbacks of this known method lies in the fact that the quantity of fibres added to the matrix is not always correctly metered, especially in cases in which this quantity is not equal to or a multiple of the content of one of the sacks mentioned above. The missing quantity of fibres has to be added to the matrix using part of the fibres contained in a further sack. Calculating this quantity is very complex and ultimately depends on the experience and competence of the operator carrying out the operation.

A further drawback lies in the fact that the operator has to add the fibres directly to the concrete production plant or to bucket conveyors for the distribution of concrete, and in both cases the operator has to scale considerable heights to be able to complete the operation.

The object of the present invention is to resolve the drawbacks of the prior art by providing a system and a method able to meter and add fibres to a cement matrix in an accurate manner without endangering the safety of the operator.

A further object of the present invention is to provide a system and a method for metering and adding fibres to a cement matrix which can be remotely actuated and controlled and mechanically operated in order to reduce to a minimum the manual work of an operator.

A further object of the present invention is to provide a system and a method able efficiently to meter and add an exact quantity of fibres to a cement matrix which is easy and economic to manufacture, reliable in use, simple to mount and requires little or no maintenance.

In order to achieve these objects, the present invention comprises a system and a method for metering and adding fibres to a cement matrix of the type described in the preamble of this specification and having the features set out in the appended claims.

Other features and advantages of the present invention will become clear from the following detailed description of a preferred embodiment of the invention which is given with reference to the appended drawings, which are provided purely by way of non-limiting example and in which:

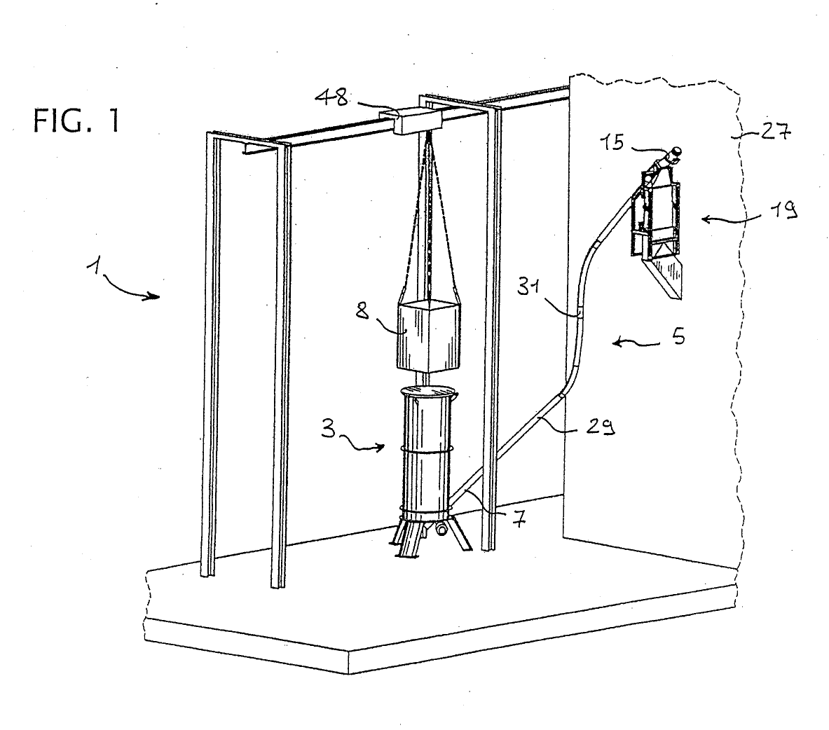

FIG. 1 is a axonometric view of the system of the present invention;

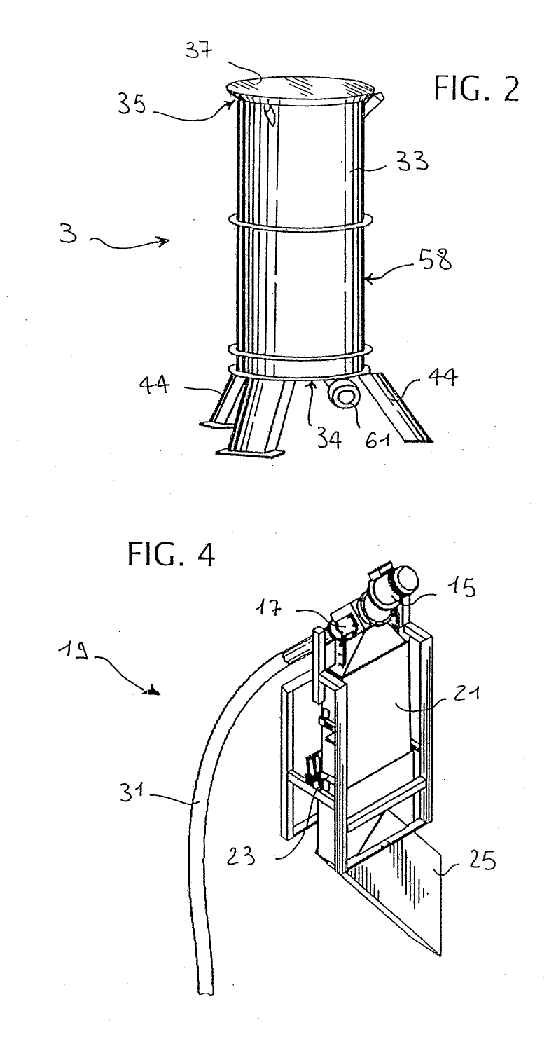

FIG. 2 is a view on an enlarged scale of the fibre supply device of the present invention;

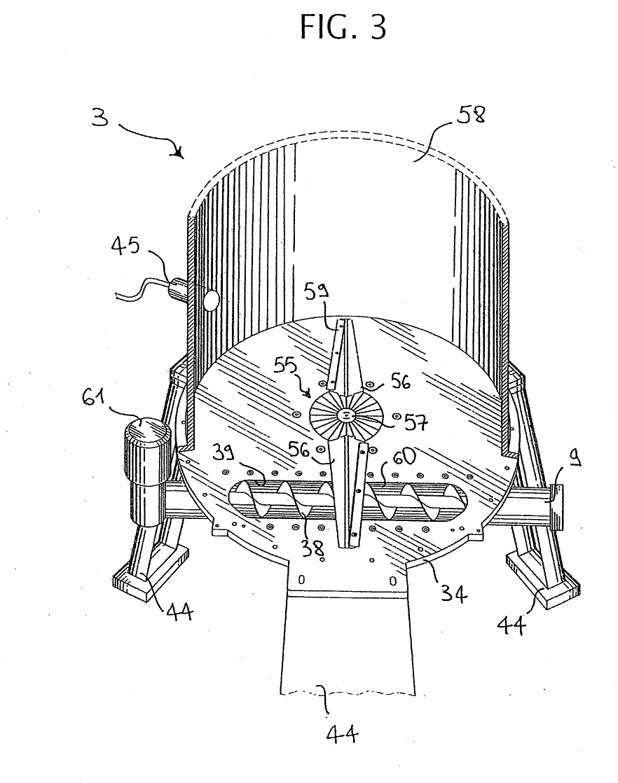

FIG. 3 is a partial view of the interior of the fibre supply device forming part of the system of FIG. 1;

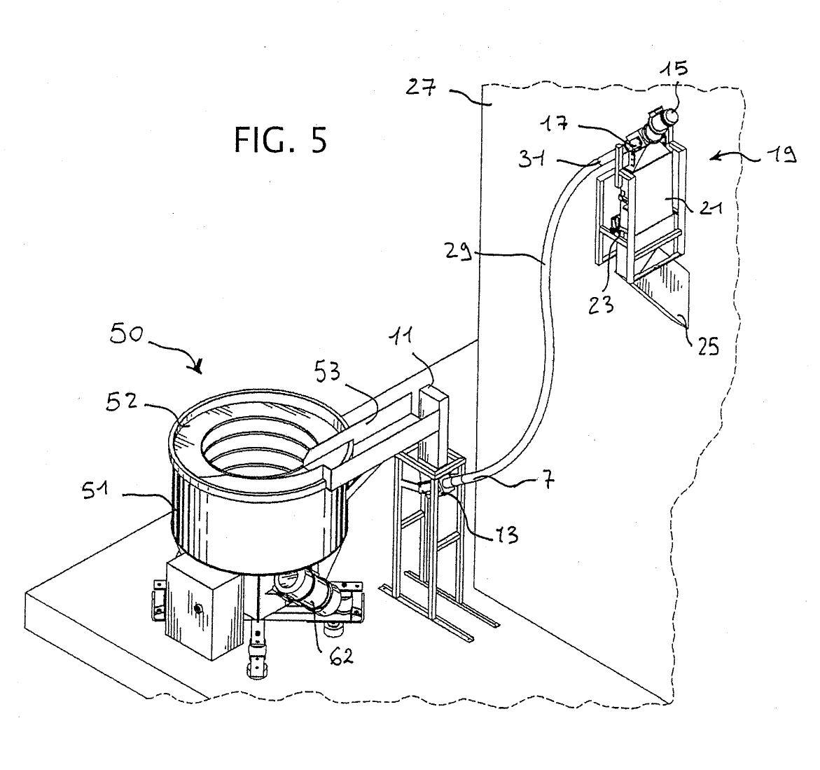

FIG. 4 is an axonometric view of a further embodiment of the system of FIG. 1.

In the drawings, a system for metering and adding fibres to a cement matrix for a cement matrix preparation plant, for instance, but not exclusively, a concrete mixing plant 27, is shown by 1.

The system for metering and adding fibres 1 comprises a supply device 3 designed to supply reinforcing elements, in particular reinforcing fibres for a cement matrix, in predetermined quantities and times. As shown in detail in FIG. 2, the supply device 3 comprises a container, preferably, but in a non-limiting manner, a tank 33 of substantially cylindrical shape elongated in a preferential direction. The tank 33 comprises a cylindrical wall 58, a base wall 34 at one end and a top opening 35 at the opposite end. Feet 44 are secured to the base wall 34 in order stably to hold the tank 33 in an upright position. The top opening 35 may be closed at will by a cover 37.

According to a particularly advantageous embodiment, the system for metering and adding fibres 1 further comprises transport means, for instance a gantry crane 48 for transporting, in operation, sacks and/or boxes 8 of fibres to the tank 33 so that the operations to load the fibres in the tank through the top opening 35 can be carried out.

As shown in FIG. 3, an agitator is provided in the tank 33 of the supply device 3. The agitator preferably, but in a non-limiting manner, comprises a rotor 55 with one or a plurality of radial blades 56 connected to a central hub 57. The hub 57 is engaged with the base wall 34 of the tank 33 and is connected to actuator means, for instance an electric motor—not shown for ease of illustration—designed to cause the rotor 55 to rotate. According to a particularly advantageous embodiment, one or more of the blades 56 of the rotor 55 are in contact with the base 34 of the tank 33, directly or via blade projections 59 fixed to the blades 56, in order efficiently to take up, in operation, fibres present on the base wall 34.

The supply device 3 further comprises sensor means, for instance, but not exclusively, a sensor 45 disposed on the cylindrical wall 58 of the tank 33. According to a particularly advantageous embodiment, the sensor 45 is disposed at a predetermined distance from the base 34 such that the sensor 45 can detect when a predetermined quantity of fibres is present in the tank 33 so as to prevent the tank from becoming completely empty during operation of the system for metering and adding fibres 1. The sensor 45 may be a proximity or optical sensor or a sensor of any other known type able to detect the presence of material in the tank 33, without thereby departing from the scope of the invention.

An opening 39 elongated in a preferential direction is obtained on a peripheral portion of the base wall 34. A plate 60 of U-shaped section, facing the opening 39, is fixed on the base 34 externally to the tank 33. A chamber, elongated in the preferential direction, is provided inside the plate 60 and contains means for the extraction of the fibres, for instance a screw extraction device 38 connected to actuator means, for instance an electric motor 61, able to cause this screw to rotate. The chamber of the plate 60 communicates with a flanged tube 9 forming an outlet for the fibres contained in the chamber.

As an alternative, the supply device comprises a single flanged tube 9 fixed to the base 34 of the tank 33 and extending in the preferential direction and externally with the respect to the base wall 34. A slot whose dimensions and shape correspond to those of the opening 39 is provided on the upper surface of the flanged tube 9. The flanged tube 9 is fixed to the tank 33 such that the slot is disposed at the location of the opening 39 thereby obtaining a configuration identical to that shown in FIG. 3.

The system for metering and adding fibres 1 further comprises conveyor means 5 designed in particular to convey the reinforcing fibres output from the supply device to the cement matrix preparation plant.

According to a feature of the present invention, the conveyor means 5 are isolated and closed with respect to the surrounding environment and in particular enable the fibres to pass through them internally without being exposed to the action of atmospheric agents. The system for metering and adding fibres of the present invention is therefore particularly suited for use with synthetic fibres, for instance polypropylene fibres, of a very low weight likely to make them particularly volatile.

As shown in FIG. 1, the conveyor means 5 comprise a duct, for instance a tube 29, within which the fibres pass, and means for moving the fibres, for instance, but not exclusively, a conveyor screw 31 disposed in the tube 29. The conveyor screw 31 is caused to rotate by actuator means, for instance, but not exclusively, an electric motor 15. According to a particularly advantageous feature of the present invention, both the tube 29 and the conveyor screw 31 are made from materials providing them with flexibility and can therefore be adapted to different operating conditions and configurations.

The conveyor means 5 comprise an inlet 7 connected to the supply device and in particular to the outlet of the flanged tube 9, and an outlet 17 positioned, preferably, but not exclusively, at a higher level than the inlet 7. This configuration of the inlet 7 and the outlet 17 of the conveyor means 5 makes it possible readily and rapidly to transfer the fibres to a level higher than ground level. This is particularly advantageous as, for logistical, operating and/or productivity reasons in particular, concrete is usually prepared at the top of a silo or in a concrete mixer.

The system for metering and adding fibres 1 further comprises a metering unit 19 connected to the outlet 17 of the conveyor means 5 and designed to receive the fibres from the conveyor means 5 and to meter them in predetermined quantities. The metering unit 19 comprises collection means, for instance a container, preferably a hopper 21, for collecting a predetermined quantity of fibres disposed in the vicinity of a material inlet of a plant for preparing a cement matrix. The hopper 21 is provided with an opening connected to the material inlet of the plant which can be closed at will by a shutter 23. The hopper 21 preferably, but not exclusively, has a load capacity of between 3 and 4 kg. The metering unit further comprises a weighing device, for instance a load cell, designed to measure the weight of the fibres contained in the hopper 21.

The metering unit 19 further comprises means for the selective opening of the hopper 21, for instance actuator means of the pneumatic, hydraulic, electric or any other type which make it possible, in use, selectively to displace the shutter 23 between an open and a closed position and vice versa. When the shutter 23 is in the closed position the fibres transferred from the conveyor means 5 to the hopper 21 are collected within the latter, and when the shutter 23 is in the open position the fibres in the hopper 21 are discharged to the material inlet of the plant. The hopper 21 is preferably connected in a direct manner to the plant for preparing a cement matrix, for instance a concrete mixing plant 27, so that the fibres discharged from the hopper 21 can be added directly to the cement matrix. As an alternative, the hopper 21 may be connected to the plant by connection means 25 such as, for instance, further ducts.

The fibre supply device, in particular the actuator means 61 of the extraction screw 38, the conveyor means, in particular the actuator means 15 of the conveyor screw 31, and the metering unit, in particular the load cell and the actuator means of the shutter 23, are all connected to processing and control means designed, in use, to manage the operation of the system as a whole and in particular to regulate the metering and addition of fibres to the cement matrix.

The method of operation of the system for metering and adding fibres 1, according to the embodiment shown in FIG. 1, comprises the stages of supplying predetermined quantities of fibres by means of a supply device 3, conveying these predetermined quantities of fibres from the supply device 3 to a predetermined position, in particular into a cement matrix production system, by means of conveyor means which keep these fibres isolated from the surrounding environment, in particular by means of conveyor means comprising at least one duct 29.

In further detail, the fibres, contained in sacks and/or boxes 8, are supplied to the tank 33, after the cover 37 has been opened, in predetermined quantities. The operations to transfer the fibres from the sacks and/or boxes 8 are carried out manually or by means of a gantry crane 48. The fibres supplied to the tank 33 are agitated by the rotating rotor 55 so as to prevent undesirable accumulations of fibres in this tank 33. The fibres moving in the tank 33 fall to the base 34 and then pass through the opening 39 and into the chamber of the plate 60. The fibres are then transferred from this chamber to the flanged tube 9 as a result of the rotation of the extraction screw 38. The fibres are conveyed from the flanged tube 9 by the conveyor screw 31 which, by rotating in the tube 29, transfers them from the inlet 7 to the outlet 17 and then to the hopper 21 at a predetermined rate of flow. When the conveyor screw 31 is in operation, the shutter 23 is disposed in the closed position so that the fibres can be collected in the hopper 21. The fibres collected in the hopper 21 are weighed at predetermined intervals as a result of the operation of the load cell which transmits the weight information to the processing and control unit. When the load cell detects the weight corresponding to a desired quantity of fibres, the processing and control means stop the rotation of the conveyor screw 31 and the supply of fibres from the supply means and open the shutter 23 so that this quantity of fibres can be transferred from the hopper 21 to the concrete mixing plant 27.

When, during operation of the system 1, the quantity of fibres in the tank 33 drops to a predetermined minimum quantity, the minimum level sensor 45 supplies an electrical signal. This electrical signal indicates that a further quantity of fibres needs to be supplied to the tank 33 to allow the metering and addition system 1 to continue to function.

With reference to FIG. 4, according to a further embodiment of the system for metering and adding fibres 1, the supply means comprise a metering device 50. The metering device 50 is formed by a hopper 51 containing a vibrating table 52, substantially spiral in shape, and an outlet 53 for the supply of fibres disposed at an apex of the hopper 51. The metering device further comprises actuator means 62 able, in use, to cause the hopper 51 to vibrate. A duct 11 is disposed downstream of the outlet 53 and communicates in turn with collection means 13, for instance a small container. The collection means 13 are connected to the inlet 7 of conveyor means 5. According to a variant of the metering device 50 shown in FIG. 4, the outlet 53 communicates directly with the inlet 7 of the conveyor means 5.

The remaining components shown in FIG. 3 correspond to the components of FIG. 1 and bear the same reference numerals and, although shown for reference purposes, are not described in further detail. In this embodiment as well, the actuator means 62 of the hopper 52, the actuator means 15 of the conveyor screw 31, the load cell and the actuator means of the shutter 23 are connected to processing and control means designed to manage the system as a whole, so as to regulate the metering and addition of fibres to the cement matrix.

In the system for metering and adding fibres 1 of the embodiment shown in FIG. 4, the fibres are loaded in this case as well by emptying sacks and/or boxes into the hopper 51 of the metering device 50. As a result of the vibrating action of the table 52, the fibres in the hopper 51 are disentangled and supplied, in predetermined quantities, via the outlet 53. The fibres supplied from the outlet 53 pass through the duct 11 and are collected in the small container 13. The fibres are then taken from the small container 13 by the conveyor screw 31 of the conveyor means 5 and added to the cement matrix in the same way as in the system 1 of FIG. 1.

Naturally, the principle of the invention remaining the same, the embodiments and details of construction may be varied widely with respect to those described and illustrated, without thereby departing from the scope of the invention.

1. A system for metering and adding synthetic fibres to a cement matrix comprising supply means (3) for supplying the synthetic fibres, conveyor means (5) for conveying the synthetic fibres designed to convey them, in use, from the supply means (3) to the cement matrix, the conveyor means (5) being closed with respect to the surrounding environment comprising a duct (29) with an inlet (7) and an outlet (17), the system comprising movement means comprising a flexible conveyor screw (31) for moving the synthetic fibres designed, in use, to move the synthetic fibres from the inlet (7) to the outlet (17) of the conveyor means (5), the outlet (17) of the conveyor means (5) being positioned at a level higher than that of the inlet (7) of the conveyor means (5), the system further comprising a fibre metering unit (19) designed to meter, in use, the synthetic fibres for the cement matrix in predetermined quantities and times, the metering unit (19) being disposed downstream of the conveyor means (5), wherein the metering unit (19) comprises collection means (21) designed to collect, in use, predetermined quantities of synthetic fibres and a device for weighing synthetic fibres designed to weigh, in use, quantities of synthetic fibres in the collection means.

2-10. (canceled)

11. A system according to claim 1, characterized in that the collection means comprise a container (21) provided with an outlet closed by a shutter (23) which may be moved at will between a closed position in which the synthetic fibres are retained in the container (21) and an open position.

12. A system according to claim 1, characterized in that the supply means (3) comprise sensor means (45) which indicate, in use, the presence of a predetermined quantity of synthetic fibres in the supply means (3).

13. A system according to claim 1, characterized in that the supply means (3) comprise a tank (33) with a base (34) provided with an agitator (55, 57, 57) comprising a rotor (55) with one or a plurality of radial blades (56) connected to a central hub (57), one or more of the blades (56) of the rotor (55) being in contact with the base (34) of the tank (33), directly or via blade projections (59) fixed to the blades (56).

14. A system according to claim 1, characterized in that the supply means (3) comprise a metering device (50) formed by a hopper (51) containing a vibrating table (52), substantially spiral in shape, and an outlet (53) for the supply of synthetic fibres disposed at an apex of the hopper (51) and communicating with the inlet (7) of the conveyor means (5), the metering device further comprising actuator means (62) able, in use, to cause the hopper (51) to vibrate.

15. A system according to claim 14, wherein a duct (11) is disposed downstream of the outlet (53) and communicates in turn with collection means (13) which are connected to the inlet (7) of conveyor means (5).

16. A method for metering and adding synthetic fibres to a cement matrix by means of a system according to claim 1, comprising the stage of:
a) supplying predetermined quantities of synthetic fibres by means of a supply device (3),
characterized in that it further comprises the stage of:
b) conveying these predetermined quantities of synthetic fibres from the supply device (3) to a predetermined position while keeping these synthetic fibres isolated from the surrounding environment.

17. A method according to claim 16, characterized in that it further comprises a stage of:
c) metering predetermined quantities of synthetic fibres for a cement matrix.
